(19) United States
(12) Patent Application Publication
(10) Pub. No.: US 2020/0151631 A1
(43) Pub. Date: May 14, 2020

(54) SYSTEM AND METHOD FOR DELIVERY OF GOODS OR SERVICES

(71) Applicant: Otter Products, LLC, Fort Collins, CO (US)

(72) Inventors: KRISTINA L. LAMERS, Fort Collins, CO (US); JESSICA A. PERRINE, Celina, TX (US); ENNIS MOSLEY, Harrisburg, PA (US)

(21) Appl. No.: 16/671,846

(22) Filed: Nov. 1, 2019

Related U.S. Application Data
(60) Provisional application No. 62/757,310, filed on Nov. 8, 2018.

(51) Int. Cl. G06Q 10/06; G06Q 10/08; G07C 9/00; G05D 1/00

(52) U.S. Cl. CPC G06Q 10/06311; G06Q 10/083; G01C 21/3438; G05D 1/0088; G07C 9/00896

(57) ABSTRACT

A method for providing transportation and a requested good or service includes receiving a first request at a first computer for transportation from a first geographic location to a second geographic location and a second request for a good or service. The method includes selecting a vehicle based on an initial geographic location of each of the plurality of vehicles relative to a location associated with the requested good or service. The method includes determining a first route from an initial geographic location of the selected vehicle to the location associated with the requested good or service, determining a second route from the location associated with the requested good or service to the first geographic location, and determining a third route from the first geographic location to the second geographic location. The method also includes transmitting the first, second and third routes to a third computer in the selected vehicle.

### CROSS REFERENCE TO RELATED APPLICATIONS

This application claims priority to U.S. Provisional Patent Application No. 62/757310, filed Nov. 8, 2018, which is hereby incorporated by reference in its entirety.

### FIELD

This disclosure relates to systems and methods for receiving and delivering goods, services, and/or riders.

### BACKGROUND

Ride sharing services have become an expanded transportation option for many users. Riders typically use a computer-based application to request transportation from a first location to a second location. The ride sharing service assigns the rider to a vehicle or a vehicle to a rider. The vehicle proceeds to the first location to meet the rider.

Users also frequently use e-commerce and online shopping to order goods and services over the internet or other network. These are typically delivered to an address provided by the user.

It would be advantageous to allow a user of a ride sharing service to deliver and/or receive goods and services in connection with their transportation.

Improved systems and methods are desired to improve efficiencies, reduce costs for shipping companies, improve timeliness for users, improve customer satisfaction, improve customer convenience, and/or support continued growth of e-commerce and online ordering activities.

### SUMMARY

Methods, systems, and techniques for delivery and receipt of goods and/or services are provided.

In one exemplary embodiment, a computer-implemented method for providing transportation with a vehicle and a requested good or service is provided. The method includes receiving a first request at a first computer for transportation from a first geographic location to a second geographic location, the first request being sent from a second computer. The method includes receiving a second request at the first computer for a good or service and associating the second request for the good or service with a location, the second request being sent from the second computer. The method includes selecting a vehicle from a plurality of available or potential vehicles, wherein the selection is based at least in part on an initial geographic location of each of the plurality of available vehicles relative to the first geographic location. The method includes determining a first route from an initial geographic location of the selected vehicle to the first geographic location. The method includes determining a second route from the first geographic location to the location associated with the requested good or service. The method includes determining a third route from the location associated with the requested good or service to the second geographic location. The method includes transmitting the first, second and third routes to a third computer in the selected vehicle. In some more particular embodiments, the method includes moving the selected vehicle from the initial geographic location of the selected vehicle to the first geographic location along the first route, moving the selected vehicle from the initial geographic location of the selected vehicle to the first geographic location along the first route, permitting a user to enter the vehicle at the first geographic location, moving the selected vehicle and user from the first geographic location to the location associated with the requested good or service along the second route, and/or moving the selected vehicle and user from the location associated with the requested good or service to the second geographic location along the third route. In some more particular embodiments, the vehicle is an autonomous vehicle and the third computer is configured to direct the autonomous vehicle to follow the transmitted first, second, and third routes.

In one exemplary embodiment, a computer-implemented method for providing transportation with a vehicle and a requested good or service is provided. The method includes receiving a first request at a first computer for transportation from a first geographic location to a second geographic location, the first request being sent from a second computer. The method includes receiving a second request at the first computer for a good or service and associating the second request for the good or service with a location, the second request being sent from the second computer. The method includes selecting a vehicle from a plurality of available vehicles, wherein the selection is based at least in part on the vehicle having an ability to deliver or receive the requested good or service while the user is in the vehicle and on an initial geographic location of each of the plurality of vehicles relative to the first geographic location. The method includes determining a first route from an initial geographic location of the selected vehicle to the first geographic location. The method includes determining a second route from the first geographic location to the second geographic location. The method includes transmitting the first and second routes to a third computer in the selected vehicle. In some more particular embodiments, the good or service is a good and the good is to be provided to the user while the user is in the vehicle. In some more particular embodiments, the good or service is a service and the service is to be provided to the user while the user is in the vehicle.

In one exemplary embodiment, a method for providing transportation and a requested good or service is provided. The method includes receiving, at a first computer, a first electronic message sent from a second computer over a network. The first electronic message includes a first request for transportation from a first geographic location to a second geographic location. The method further includes receiving, at the first computer, a second electronic message from the second computer over the network. The second electronic message includes a second request for a good or service. The method also includes determining a physical location where the good or service is available and linking the physical location with the second request. The method further includes selecting a vehicle from a list of available vehicles where the selection is based at least in part on initial geographic locations of each of the available vehicles. The method further includes calculating a first route from the initial geographic location of the selected vehicle to the first geographic location, calculating a second route from the first geographic location to the physical location where the good or service is available, and calculating a third route from the physical location where the good or service is available to the second geographic location. Finally, the method includes transmitting the first, second, and third routes to a third computer in the selected vehicle and dispatching the selected vehicle to the initial geographic location.

In one exemplary embodiment, a computer-implemented method for providing transportation with a vehicle and a requested good or service is provided. The method includes receiving a first request at a first computer for transportation from a first geographic location to a second geographic location, the first request being sent from a second computer. The method includes receiving a second request at the first computer for a good or service and associating the second request for the good or service with a location, the second request being sent from the second computer. The method includes selecting a vehicle from a plurality of available vehicles, wherein the selection is based at least in part on an initial geographic location of each of the plurality of vehicles relative to the location associated with the requested good or service. The method includes determining a first route from an initial geographic location of the selected vehicle to the location associated with the requested good or service. The method includes determining a second route from the location associated with the requested good or service to the first geographic location. The method includes determining a third route from the first geographic location to the second geographic location. The method includes transmitting the first, second and third routes to a third computer in the selected vehicle.

In one exemplary embodiment, a computer-implemented method for providing transportation with a vehicle and a requested good or service is provided. The method includes receiving a first request at a first computer for transportation from a first geographic location to a second geographic location, the first request being sent from a second computer. The method includes receiving a second request at the first computer for a good or service and associating the second request for the good or service with a location, the second request being sent from the second computer. The method includes selecting a vehicle from a plurality of available vehicles, wherein the selection is based at least in part on an initial geographic location of each of the plurality of vehicles relative to the first geographic location. The method includes determining a first route from an initial geographic location of the selected vehicle to the first geographic location. The method includes determining a second route from the first geographic location to the second geographic location. The method includes determining a third route from the second geographic location to the location associated with the requested good or service. The method includes transmitting the first, second and third routes to a third computer in the selected vehicle.

In one exemplary embodiment, a computer-implemented method for providing transportation with a first vehicle and a second vehicle. The method includes receiving a request at a first computer for transportation from a first geographic location to a second geographic location and then to a third geographic location, the request being sent from a second computer. The method includes selecting the first vehicle from a plurality of available vehicles, wherein the selection is based at least in part on an initial geographic location of each of the plurality of vehicles relative to the first geographic location. The method includes determining a first route from an initial geographic location of the selected vehicle to the first geographic location. The method includes determining a second route from the first geographic location to the second geographic location. The method includes providing access to the second vehicle for transportation from the second geographic location to the third geographic location.

In one exemplary embodiment, a computer-implemented method for providing transportation with a first vehicle and a second vehicle. The method includes receiving a request at a first computer for transportation from a first geographic location to a second geographic location and then to a third geographic location, the request being sent from a second computer. The method includes selecting the first vehicle from a plurality of available vehicles, wherein the selection is based at least in part on an initial geographic location of each of the plurality of vehicles relative to the second geographic location. The method includes providing access to the second vehicle for transportation from the first geographic location to the second geographic location. The method includes determining a first route from an initial geographic location of the selected vehicle to the second geographic location. The method includes determining a second route from the second geographic location to the third geographic location.

While multiple embodiments are disclosed, still other embodiments will become apparent to those skilled in the art from the following detailed description and figures, which describe and show illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying figures.

FIG. 1 illustrates an operating environment for a user to deliver or receive a good and/or service.

FIG. 2 illustrates a plurality of possible routes for delivery or receiving a good and/or service.

FIG. 3 is a flow chart illustrating an exemplary method for delivering or receiving a good or service.

FIG. 4 is a flow chart illustrating an exemplary method for delivering or receiving a good or service.

FIG. 5 is a flow chart illustrating an exemplary method for delivering or receiving a good or service.

FIG. 6 is a flow chart illustrating an exemplary method for delivering or receiving a good or service.

FIG. 7A is a flow chart illustrating an exemplary method for transporting a user.

FIG. 7B is a flow chart illustrating another exemplary method for transporting a user.

### DETAILED DESCRIPTION

In the following detailed description, various specific details are set forth in order to provide an understanding of and describe the apparatuses and techniques introduced here. However, the techniques may be practiced without the specific details set forth in these examples. Various alternatives, modifications, and/or equivalents will be apparent to those skilled in the art without varying from the spirit of the introduced apparatuses and techniques. For example, while the embodiments described herein refer to particular features, the scope of this solution also includes embodiments having different combinations of features and embodiments that do not include all of the described features. Accordingly, the scope of the techniques and solutions introduced herein are intended to embrace all such alternatives, modifications, and variations as fall within the scope of the claims, together with all equivalents thereof. Therefore, the description should not be taken as limiting the scope of the invention, which is defined by the claims.

As described above, improved systems and methods are needed for delivering goods and/or services to a user.

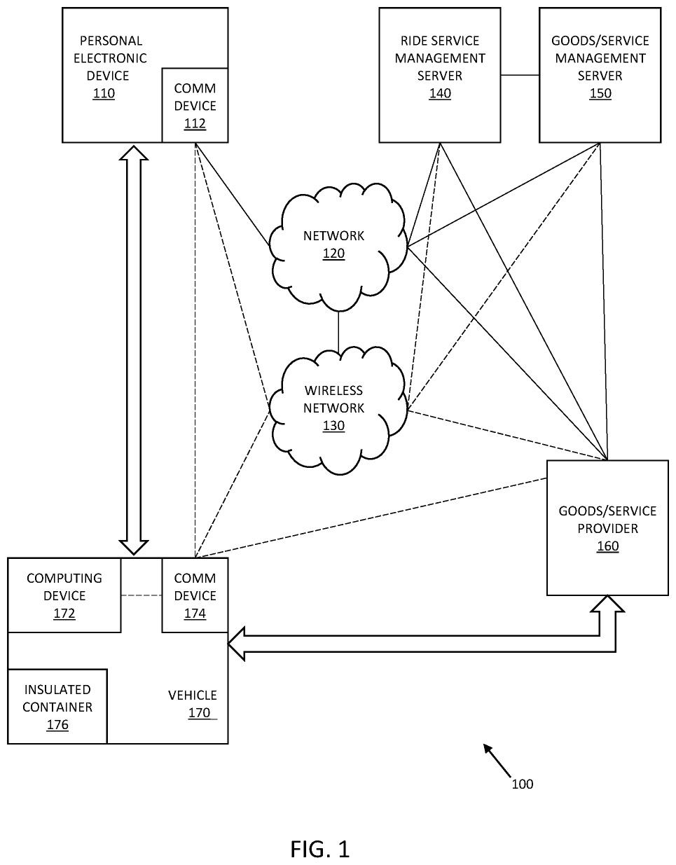

FIG. 1 illustrates an operating environment 100 for a user ordering and receiving goods and/or services. In FIG. 1, dashed lines are generally used to represent wireless communication links and solid lines are generally used to represent wired communication links. However, it should be understood that any of the wireless communication links may be implemented as wired communication links and any of the wired communication links may be implemented as wireless communication links, including combinations thereof. Physical movement of users, vehicles, goods and services is represented by the various arrows.

A user of the systems and methods disclosed herein is associated with and uses a personal electronic device 110. Personal electronic device 110 is any type of personal or portable electronic device used for communication, information retrieval, information viewing, and/or data storage. Personal electronic device 110 may be a cellular phone, a smartphone, a mobile communication device, a mobile computing device, a portable computing device, a tablet, a phablet (phone/tablet), a portable computer, a personal video player, an electronic media reader, an audio player, a fitness or health tracking device, a handheld scanner, a camera, a GPS device, and/or an electronic computing or communication device of another type, including combinations thereof.

Personal electronic device 110 includes a communication device 112. Communication device 112 may be configured and/or adapted for uni-directional and/or bidirectional communication. Communication device 112 may include any type of electrical or electronic components such as a transmitter, a receiver, a modulator, a demodulator, an amplifier, an antenna, a mixer, a filter, a computer processor, a digital signal processor, memory, analog components, digital components, an integrated circuit, an application specific integrated circuit (an ASIC), a programmable device, a printed circuit board, an electrical connector, an electromechanical connector, and/or any other electrical, electronic, and/or electromechanical components for performing communication functions. Communication device 112 may be configured for wired and/or wireless communication methods. Communication device 112 may utilize or comply with one or more communication formats, protocols, or systems including: cellular communication standards, LTE, eMBB, URLLC, mMTC, UMTS, WiMAX, EV-DO, CDMA, GSM, Bluetooth, Bluetooth Low Energy, Bluetooth Smart, Wireless Fidelity (WiFi), Zigbee, ANT, ANT+, Thread, Internet Protocol (IP), Ethernet, Fast Ethernet, Gigabit Ethernet, ATM, FDDI, Near Field Communication (NFC), proprietary formats or protocols, and/or combinations thereof.

Personal electronic device 110 may be used to communicate with other devices described herein using one or more of wired and/or wireless communication methods. Personal electronic device 110 may incorporate or communicate directly with one or more communication devices 112 when in proximity to communication devices 112 and may also communicate with them through one or more of network 120 and wireless network 130, particularly when in other geographic locations.

Personal electronic device 110 includes a plurality of hardware and software, including a controller. Personal electronic device 110 may include a controller including logic which may control operating of personal electronic device 110. Personal electronic device 110 may include one or more computer processors or other structures to implement the logic of the controller. The logic of the computing device 110 may be implemented in hardware or in hardware executing software. Exemplary software may be stored in a memory that includes instructions executed by the controller. Memory is a computer readable medium and may be a single storage device or may include multiple storage devices, located either locally with personal electronic device 110 or accessible across a network, such as network 120 or wireless network 130. Computer-readable media may be any available media that may be accessed by the controller and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, servers, Digital Versatile Disk (DVD) or other optical disk storage, magnetic cassettes, magnetic tape, magnetic disk storage or other magnetic storage devices, or any other medium which may be used to store the desired information and which may be accessed by the controller.

In one embodiment, personal electronic device 110 communicates data, status information, or a combination thereof to a remote device for storage, analysis, or carrying out a predetermined command. In another embodiment, memory may further include operating system software. Memory further includes communications software for communication with a network, such as a local area network, a public switched network, a CAN network, and any type of wired or wireless network. An exemplary public switched network is the Internet. Exemplary communications software includes e-mail software, SMS, Bluetooth communication software, radio frequency communication software, near field communication software and internet browser software. Other suitable software which permit the personal electronic device 110 to communicate with other devices across a network may be used.

Network 120 includes any network or combination of networks or components used for electronic communication, including the Internet. While network 120 is illustrated as a single element, network 120 may include many different elements, such as routers, hubs, gateways, and/or other networks. Network 120 may be distributed across or throughout a wide variety of geographical locations.

Wireless network 130 includes any network or combination of networks or components for electronic wireless communication, including cellular systems and networks. While wireless network 130 is illustrated as a single element, wireless network 130 may include many different elements such as antennas, routers, hubs, and gateways, other networks, and may be distributed across a wide variety of geographical locations. In one example, wireless network 130 may include a local cellular antenna, and accompanying systems, through which communication device 112 and/or other devices conduct wireless communication.

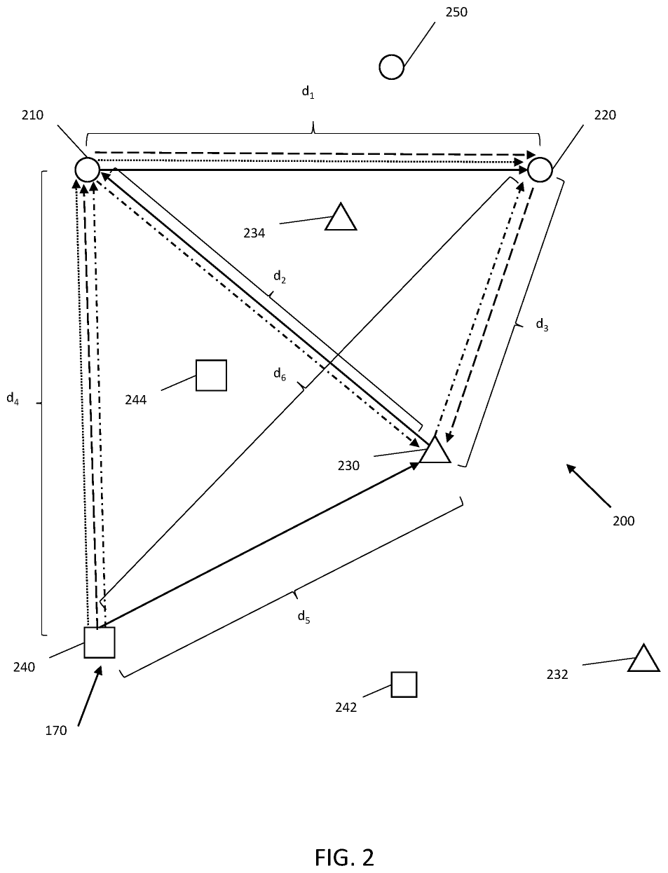

In environment 100, a user associated with personal electronic device 110 and located at a first geographic location 210 (see FIG. 2) sends a request to ride service management server 140 through network 120 or wireless network 130 as described in more detail in the examples herein. In some exemplary embodiments, the request includes a request for transportation to a second geographic location 220 (FIG. 2). In some embodiments, the first geographic location 210 is spaced apart from the second geographic location 220. In some embodiments, the first geographic location 210 is the same as the second geographic location 220. Ride management server 140 may be any computer, computer systems, or group of computers or computer systems. Ride management server 140, in conjunction with associated software, is used to implement and manage one or more transportation services, such as a ride share service, through electronic communications and data exchange.

In some exemplary embodiments, the request is an electronic message that includes a request for a particular good or service to be delivered and/or provided. In some exemplary embodiments, the request for the particular good or service is made by the user concurrently with the request for transportation as part of the same request. In some exemplary embodiments, the request for the good or service is included in a separate request. In some more particular embodiments, one or more requests may be made by a user using personal electronic device 110 through network 120 and/or wireless network 130 to ride management server 140, which then communicates with goods/service management server 150 regarding the requested good and/or service. Goods/service management server 150 may be any computer, computer systems, or group of computers or computer systems. Goods/service management server 150, in conjunction with associated software, is used to implement and manage one or more systems for providing or distributing goods or services provided by a goods/service provider, such as goods/service provider 160.

In some more particular embodiments, one or more requests for transportation are made using personal electronic device 110 through network 120 and/or wireless network 130 to ride management server 140 and one or more requests for a particular good and/or service are made by a user using personal electronic device 110 through network 120 and/or wireless network 130 to goods/service management server 150. In other more particular embodiments, one or more requests for transportation are made by a user using personal electronic device 110 through network 120 and/or wireless network 130 to ride management server 140 and one or more requests for a particular good and/or service are made by a user using personal electronic device 110 through network 120 and/or wireless network 130 to ride service management server 140, which is in communication with goods/service management server 150 regarding the requested good and/or service.

In some exemplary embodiments, ride service management server 140 and goods/services management server 150 include some degree of coordination or arrangement between the two or more entities. Exemplary coordination and arrangement features include recommendations for a requested good or service, recommendations for a location 230 associated with a requested good or service, recommendations for a second geographic location 220, discounts for users for a requested good/service or transportation of the user, commissions exchanged between businesses associated with one or more of the ride service management server 140 and the goods/services management server 150, automatic or subscription chargers to an account associated with the user related to either ride service management server 140 and goods/services management server 150, repeating a previous order or suggesting repetition of a previous order, providing priority in one or more systems or requests associated with a user based on a relationship in the ride service management server 140 and goods/services management server 150, and coordinating and/or exchanging information related to arrival time, transport time, or a time associated with the receipt or delivery of the requested good or service.

In some embodiments, ride management server 140 may include information pertaining to a geographic location 230 (FIG. 2) associated with the requested good or service. In other embodiments, ride management server 140 is in communication with a separate goods or services management server 150 that includes information pertaining to the geographic location 230 associated with the requested good or service, either directly or through a network, such as network 120 or wireless network 130. Either ride service management server 140, and/or goods/service management server 150 may be in contact with the goods/services provider 160, such as to confirm available inventory or appointment availability.

Ride service management server 140 provides information relating to the user's pick-up or first geographic location 210, requested drop-off or second geographic location 220, and the requested good and/or service and associated geographic location 230 of a vehicle to fulfill the request. Vehicle 170 is illustrated as a single vehicle but may include a variety of vehicles or transport mechanisms to complete the entire transportation process including: one or more trucks, one or more cars, one or more self-driving vehicles, one or more aircraft, one or more boats, one or more bicycles, one or more scooters, and/or one or more unmanned aerial devices, such as drones. In some exemplary embodiments, vehicle 170 is autonomous. In the case of an autonomous vehicle, vehicle 170 may be controlled, driven, directed, dispatched, and/or navigated by one or more computer systems including computing device 172 and ride management server 140. In some exemplary embodiments, vehicle 170 is at least partially controlled by the user of personal electronic device 110. In some exemplary embodiments, vehicle 170 is at least partially controlled by a third party, such as a driver. The transport services may be provided in part by or in conjunction with one or more delivery service entities such as United Parcel Service (UPS), Federal Express (FedEx), DHL, The United States Postal Service (USPS), other postal service providers, local delivery services, local couriers, and/or combinations thereof.

In some situations, vehicle 170 and/or an operator of vehicle 170 may use portable computing device 172 having an associated communication device 174 to gather, receive, store, and/or transmit information related to the requested transport of the user and/or delivery of the requested goods/services. Among other functions, portable computing device 172 may be used to receive one or more suggested routes for the vehicle to take to transport the user and provide or deliver the requested good/service, as well as a current status of the requested transportation and a current status of the requested good/service. Portable computing device 172 may communicate with other devices or systems, including the user's personal electronic device 110 and/or goods/services provider 160, through wireless network 130 and/or through another communications system, including a system included in vehicle 170.

In some exemplary embodiments, vehicle 170 includes one or more insulated containers 176 to maintain a temperature of a requested good at a temperature other than ambient. In some embodiments, the insulated container 176 may be used to keep one or more food or beverage items at a cool or cold temperature. In other embodiments, the insulated container 176 may be used to keep one or more food or beverage items at a warm or hot temperature. Insulated container 176 may also include active heating and/or cooling elements.

As discussed in the various examples herein, the request from the user's personal electronic device 110 to ride service management server 140 includes a request for transportation for the user as well as a request for a good or service. This any of the other functions described herein which are performed on personal electronic device 110, or any other computing device disclosed herein, may be performed using a software application or software app executed on the computing device.

FIG. 2 illustrates an exemplary geographic area 200. It is to be noted that geographic area 200 is provided for illustrative purposes only, and the scale, orientation, and/or relative locations within geographic area 200 are not intended to be limiting in any way.

The geographic area 200 includes the first geographic location 210 of the user, such as the user's current geographic location or a point at which the user wishes to be picked up for transport. In some embodiments, the first geographic location 210 may be determined by a location sensor contained within personal electronic device 110, such as a GPS device. In other embodiments, the first geographic location 210 may be input into the personal electronic device 110 by the user.

The geographic area 200 also includes the second geographic location 220 of the user, such as the user's requested end location or point at which the user wishes to be dropped off by vehicle 170. The first geographic location 210 and second geographic location 220 are illustratively separated by a first distance d₁. The various distances discussed herein may represent a direct distance or may represent a commuting or transport distance required by a vehicle to get between the points as determined through use of an electronic map system.

The geographic area 200 also includes an initial geographic location 230 of associated with the good or service requested by the user, such as an initial geographic location or an inventory location of the requested good or a geographic location at which at least a portion of the requested service is to be received or performed. Additional locations associated with the requested good/service may also be present in the geographic area 200 at other geographic locations, including more distant locations 242 and closer locations 244. In some exemplary embodiments, the geographic location 230 associated with the requested good and/or service is selected by ride service management server 140 and/or goods/service management server 150. In some exemplary embodiments, the geographic location 230 associated with the requested good and/or service is selected by the user of personal electronic device 110. In some exemplary embodiments, the geographic location 230 associated with the requested good and/or service is selected by the user of personal electronic device 110 from a listing provided by ride service management server 140 and/or by goods/service management server 150. The first geographic location 210 and second geographic location 230 are illustratively separated by a second distance d₂. The second geographic location 220 and location 230 are illustratively separated by a third distance d₃.

The geographic area 200 further includes a geographic location 240 of the vehicle 170, such as an initial or expected geographic location of vehicle 170 when the request for transport is received by ride service management server 140. The first geographic location 210 and the initial geographic location 240 of the vehicle 170 are illustratively separated by a fourth distance d₄. Additional vehicles 170 may also be present in the geographic area 200 at other geographic locations, including more distant locations 232 and closer locations 234. Vehicle 170 may be selected from a list or pool of vehicles that are available at the time. The pool of vehicles may be included as part of the system. The location 220 and vehicle location 240 are illustratively separated by a fifth distance d₅. The second geographic location 220 and vehicle location 240 are illustratively separated by a sixth distance d₆.

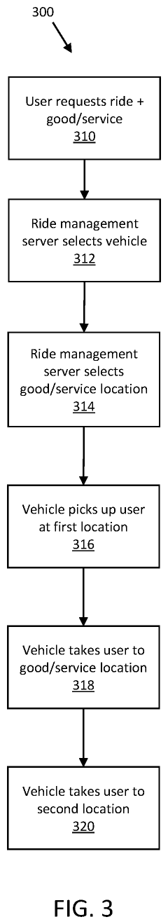

Referring next to FIGS. 3-7B, multiple methods 300, 350, 400, 450, 500, 550 of providing a good and/or service to a user associated with personal electronic device 110 during transportation between locations 210 and 220 are illustrated. Exemplary goods to be provided in methods 300, 350, 400, 450, 500, 550 include, but are not limited to, a battery charger and/or charging cables for a portable electronic device, one or more food items, one or more beverages, one or more pharmaceutical or medical products, one or more magazines, documents, books or other reading materials, one or more maps, and/or one or more other previously ordered items. Exemplary services to be provided in methods 300, 350, 400, 450, 500, 550 include, but are not limited to, battery re-charging services, pharmacy services, grocery services, dry cleaning services, transportation services, shipping or delivery services, package lockers or storage services, and/or food or beverage services.

In some exemplary embodiments, the user associated with personal electronic device 110 provides payment for the transportation to the ride service management server 140 through the personal electronic device 110. In some exemplary embodiments, the user associated with personal electronic device 110 provides payment for the requested good and/or service to the ride service management server 140 and/or goods/service management server 150 through the personal electronic device 110. In some exemplary embodiments, the user associated with personal electronic device 110 provides a single payment for the transportation and requested goods/services through personal electronic device 110 to ride service management server 140, and ride service management server 140 provides a portion of the payment to goods/service management server 150.

The good or service may be delivered or provided in any suitable way at location 230. In some exemplary embodiments, the location 230 is a retail establishment, and the requested good or service is delivered to or received by the user associated with personal electronic device 110, vehicle 170 (or a driver thereof). In some exemplary embodiments, the location 230 includes a storage or locker feature, and the requested good or service is delivered or received by the user associated with personal electronic device 110, vehicle 170 (or a driver thereof).

In more particular embodiments, the storage or locker feature may be electronically unlocked by the user using a code provided by ride service management server 140 and/or goods/service management server 150 to personal electronic device 110 or an electronic signal from communication device 112 to the storage or locker feature. In other more particular embodiments, the storage of locker feature may be electronically unlocked by the vehicle 170 (or a driver thereof) using a code provided to by ride service management server 140 and/or goods/service management server 150 to computing device 172 or an electronic signal from communication device 174 to the storage or locker feature. In some exemplary embodiments, the location 230 accepts or receives a delivered good, and then sends the good to a separate location where a requested service is performed.

Although methods 300, 350, 400, 450, 500, 550 each refer to the transportation of the user associated with personal electronic device 110 from a first geographic location 210 to a second geographic location 220, in some embodiments, each method 300, 350, 400, 450, 500, 550 includes transportation of the user between three or more geographic locations (not shown in FIG. 2).

Although methods 300, 350, 400, 450, 500, 550 each refer to the provision or delivery of a single good or service, in some embodiments, each method 300, 350, 400, 450, 500, 550 includes the provision or delivery of multiple goods, multiple services, and/or multiple goods and multiple services. In some embodiments, each of the goods or services is associated with the same geographic location 230. In some embodiments, the goods and services and associated with two or more geographic locations which are integrated into the disclosed methods in similar manners.

Although methods 300, 350, 400, 450, 500, 550 are illustrated individually in FIGS. 3-7B, in some embodiments, a method may include any combination or repetition of one or more of methods 300, 350, 400, 450, 500, 550. Further, any of the disclosed methods may include any portion of any other method disclosed herein.

Although methods 300, 350, 400, 450, 500, 550 are illustrated for a single user and a single good or service in FIGS. 3-7B, in some embodiments a method may include one or more users communicating with ride service management server 140 to each obtain transportation within geographic area 200 from a first geographic location 210 to a second geographic location 220. Each first geographic location 210 and second geographic location 220 may be the same or different for each of the one or more users. In some embodiments, the first geographic location 210 for one of the one or more users may be the same as or different from as the second geographic location 220 for another of the one or more users. In some embodiments, requested good/service for one of the one or more users may be the same as or different as the requested good/service for another of the one or more users, and the location 230 associated with the requested good/service for one of the one or more users may be the same as or different as the location 230 associated with the requested good/service for another of the one or more users. In some embodiments, the first geographic location 210 and/or the second geographic location 220 for one of the one or more users may be the same as or different from as the location 230 associated with the requested good/service for another of the one or more users. In routes with one or more users, each of the routes between the various locations, such as locations 210, 220, 230, and 240 for each user, may be transmitted or provided to the computing device 172 of vehicle 170 by the ride service management server 140.

In some exemplary embodiments, ride service management server 140 may manage the time at which vehicle 170 arrives at a designated location 210, 220, 230, or 240 based on a predetermined criteria. Exemplary criteria include an expected route transit time (such as determined by distance, traffic, time of day, type of road, speed limits, past history, road construction, number of stops, etc.), a time requested by the user associated with personal electronic device 110, a time requested by goods/service provider 160, a time communicated by goods/service management server 150, an expected time to receive or deliver the requested good, and/or an expected time to receive or perform the requested service. Any of the routes discussed herein may be determined, calculated, re-calculated, updated, and/or revised based on any combination of these criteria.

Referring to FIG. 3 in combination with FIGS. 1 and 2, an illustrative method 300 for providing a good or service is provided. In some exemplary embodiments, method 300 follows the dot-dash lines in FIG. 2 from initial location 240 of vehicle 170 to second geographic location 220.

In step or block 310, a user associated with personal electronic device 110 in geographic area 200 requests transportation from a first geographic location 210 to a second geographic location 220, as well as a good or service associated with a geographic location 230. The request is electronically transmitted to ride management server 140.

In block 312, the ride service management server 140 selects a vehicle 170 to provide transportation to the user. Ride management server 140 may identify one or more vehicles 170 in geographic area 200, such as vehicles at locations 240, 242, and 244. In some embodiments, ride management server 140 is in communication with computing device 172 in one or more vehicles 170 to determine a location 240 and/or status of vehicle 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, pre-defined service areas, a rating of a driver associated with vehicle 170, acceptance by the driver associated with vehicle 170 of the request or user, the distance d₄ between the current geographic location 240 of the vehicle 170 and the first geographic location 210, the distance d₂ between the first geographic location 210 and the geographic location 230 associated with the good/service, the distance d₃ between the geographic location 230 associated with the good/service and the second geographic location 220, and/or the total distance d₄+d₂+d₃.

In block 314, the ride service management server 140 selects a location 230 associated with the requested good/service. Ride management server 140 may identify one or more locations associated with the requested good/service in geographic area 200, such as locations 230, 232, and 234. In some embodiments, ride management server 140 is in communication with good/service management server 150 to identify and select among locations 230, 232, and 234 for providing the good/service. Location 230 is selected over other locations, such as locations 232 and 234, based on one or more criteria. Exemplary criteria include, but are not limited to, availability or inventory of the requested good/service at the location, estimated time to complete the requested transportation and good/service delivery, a preference or selection of the user associated with personal electronic device 110 among locations 230, 232, and 234, a preference or selection of the driver associated with v among locations 230, 232, and 234, rating of the locations 230, 232, and 234 associated with the requested good/service, the distance d₄ between the current geographic location 240 of the vehicle 170 and the first geographic location 210, the distance d₂ between the first geographic location 210 and the geographic location 230 associated with the good/service, the distance d₃ between the geographic location 230 associated with the good/service and the second geographic location 220, and/or the total distance d₄+d₂+d₃.

In some embodiments, block 312 is performed prior to block 314. In some embodiments, block 312 is performed following block 314. In some embodiments, block 312 is performed simultaneously with block 314.

In block 316, the vehicle 170 moves from location 240 to the requested first geographic location 210 of the user associated with personal electronic device 110, covering distance d₄. In some embodiments, the route associated with distance d₄ is transmitted or provided to the computing device 172 of vehicle 170 by the ride service management server 140. In some examples, a door of vehicle 170 is electronically unlocked when the vehicle reaches first geographic location 210 to allow the user to enter the vehicle.

In block 318, the vehicle 170 transports the user associated with personal electronic device 110 from the first geographic location 210 to the location 230 associated with the requested good/service, covering distance d₂, where the user delivers and/or receives the requested good and/or service. In some embodiments, the route associated with distance d₂ is transmitted or provided to the computing device 172 of vehicle 170 by the ride service management server 140.

In block 320, the vehicle 170 transports the user associated with personal electronic device 110 from the location 230 to the second geographic location 220, covering distance d₃. In some embodiments, the route associated with distance d₃ is transmitted or provided to the computing device 172 of vehicle 170 by the ride service management server 140.

Without intending to be limiting in any way, in some exemplary embodiments, method 300 may be used by a user to pick up food, dry cleaning, a pharmaceutical or medical product, or a grocery order at location 230 while being transported from first geographic location 210 to second geographic location 220, such as on the trip home from work. In this way, a user associated with personal electronic device 110 can more efficiently access the location 230 associated with the requested good or service during transportation from the first geographic location 210 to the second geographic location 220, without having to arrange multiple or separate ride transactions. In some cases, ride service management server 140 and/or goods/service management server may plan the order for the good/service such that it is ready or available at or near the estimated time of arrival at location 230. Similarly, the order may be adjusted based on a revised estimated arrival time which may change due to traffic or other situations.

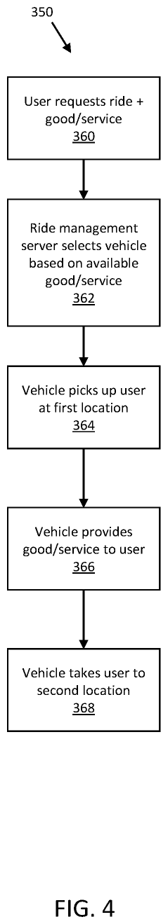

Referring next to FIG. 4 in combination with FIGS. 1 and 2, an illustrative method 350 for providing a good or service is provided. In some exemplary embodiments, method 350 follows the dot-dot lines in FIG. 2 from initial location 240 of vehicle 170 to second geographic location 220.

In block 360, a user associated with personal electronic device 110 in geographic area 200 requests transportation from a first geographic location 210 to a second geographic location 220, as well as requests a good or service to be received by or delivered to the user.

In block 362, the ride service management server 140 selects a vehicle 170 to provide transportation to the user. Ride management server 140 may identify one or more vehicles 170 in geographic area 200, such as vehicles at locations 240, 242, and 244. In some embodiments, a specific pool of available vehicles may be queried. In some embodiments, ride management server 140 is in communication with computing device 172 in one or more vehicles 170 to determine a location 240 and/or status of vehicle 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, a rating of a driver associated with vehicle 170, acceptance of the driver associated with vehicle 170 to accept the requested user, the distance d₄ between the current geographic location 240 of the vehicle 170 and the first geographic location 210, the distance d₁ between the first geographic location 210 and the second geographic location 220, and/or the total distance d₄+d₁. Any of the routes discussed herein may be determined, calculated, re-calculated, updated, and/or revised based on any combination of these criteria.

In block 364, the vehicle 170 moves from location 240 to the requested initial location 210 of the user associated with personal electronic device 110, covering distance d₄. In some embodiments, the route associated with distance d₄ is provided to the computing device 172 of vehicle 170 by the ride service management server 140. Once the user associated with personal electronic device 110 is picked up by vehicle 170, the requested good/service is provided to the user. Because of the selection of the appropriate vehicle 170, the requested good/service is already available in the vehicle 170 to be provided to the user (block 366) after the vehicle meets the user at the first geographic location 210.

In block 368, the vehicle 170 transports the user associated with personal electronic device 110 from the requested initial location 210 to the second geographic location 220, covering distance d₁. In some embodiments, the route associated with distance d₁ is transmitted to or provided to the computing device 172 of vehicle 170 by the ride service management server 140.

Without intending to be limiting in any way, in some exemplary embodiments, method 350 may be used by a user to purchase a battery or battery charger for personal electronic device 110 in vehicle 170 during transportation from first geographic location 210 to second geographic location 220. In another example, method 350 may be used by a user to have a desired charging interface available in vehicle 170 during transportation from first geographic location 210 to second geographic location 220. In another example, method 350 may be used by a user to have a desired food or beverage product in vehicle 170 during transportation from first geographic location 210 to second geographic location 220.

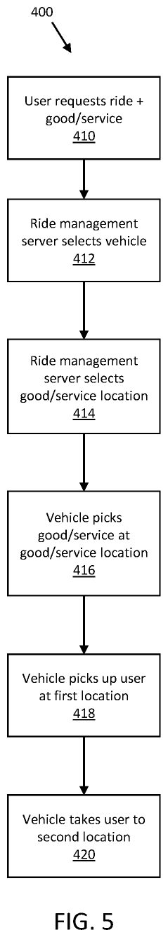

Referring next to FIG. 5 in combination with FIGS. 1 and 2, an illustrative method 400 for providing a good or service is provided. In some exemplary embodiments, method 400 follows the solid lines in FIG. 2 from initial location 240 of vehicle 170 to second geographic location 220.

In block 410, a user associated with personal electronic device 110 in geographic area 200 requests transportation from a first geographic location 210 to a second geographic location 220, as well as a good or service associated with or available at a geographic location 230. The request for transportation and the good/service request may be electronically transmitted from personal electronic device 110 in a single message or in separate messages.

In block 412, the ride service management server 140 selects a vehicle 170 to provide transportation to the user. Ride management server 140 may identify one or more vehicles 170 in or near geographic area 200, such as vehicles at locations 240, 242 and 244. In some embodiments, ride management server 140 is in communication with computing device 172 in one or more vehicles 170 to determine a location 240 and/or status of vehicles 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, a rating of a driver associated with vehicle 170, type of vehicle, acceptance of the driver associated with vehicle 170 to accept the requested user, the distance d₅ between the current geographic location 240 of the vehicle 170 and the location 230 associated with the requested good/service, the distance d₂ between the location 230 associated with the requested good or service and the first geographic location 210, the distance d₁ between the first geographic location 210 and the second geographic location 220, and/or the total distance d₅+d₂+d₁.

In block 414, the ride service management server 140 selects a location 230 associated with the requested good/service. Ride management server 140 may identify one or more locations associated with the requested good/service in geographic area 200, such as locations 230, 232, and 234. In some embodiments, ride management server 140 is in communication with good/service management server 150 to identify and select among locations 230, 232, and 234 for providing the good/service. Location 230 is selected over other locations, such as locations 232 and 234 based on one or more criteria. Exemplary criteria include, but are not limited to, availability or inventory of the requested good/service at the location, estimated time to complete the requested transportation and good/service delivery, a preference or selection of the user associated with personal electronic device 110 among locations 230, 232, and 234, a preference or selection of the driver associated with vehicle 170 among locations 230, 232, and 234, rating of the locations 230, 232, and 234 associated with the requested good/service, the distance d₂ between the location 230 associated with the requested good or service and the first geographic location 210, the distance d₁ between the first geographic location 210 and the second geographic location 220, and/or the total distance d₅+d₂+d₁.

In some embodiments, block 412 is performed prior to block 414. In some embodiments, block 412 is performed following block 414. In some embodiments, block 412 is performed simultaneously with block 414.

In block 416, the vehicle 170 moves from location 240 to the location associated with the requested good/service 230, covering distance d₅, where the vehicle (or driver thereof) delivers and/or receives the requested good or service. In some embodiments, the route associated with distance d₅ is provided to the computing device 172 of vehicle 170 by the ride service management server 140. In some embodiments, the requested good may be stored in insulated container 176 of vehicle 170 to maintain a temperature of the good at a temperature other than ambient. In the case of an autonomous or semi-autonomous vehicle, one or more computers may direct, control, guide, drive, or navigate vehicle 170 to move it from one location to another.

In block 418, the vehicle moves from location 230 to the first geographic location 210 of the user associated with personal electronic device 110, covering distance d₂. In some embodiments, the route associated with distance d₂ is provided to the computing device 172 of vehicle 170 by the ride service management server 140.

In block 420, the vehicle 170 transports the user associated with personal electronic device 110 from the first geographic location 210 to the second geographic location 220, covering distance d₁. In some embodiments, the route associated with distance d₁ is provided to the computing device 172 of vehicle 170 by the ride service management server 140.

Without intending to be limiting in any way, in some exemplary embodiments, method 400 may be used by a user to have vehicle 170 pick up a good, such as a package, dry cleaning, or a food or beverage product, prior to picking up the user at the first geographic location 210. In some exemplary embodiments, a food or beverage good may be kept at a non-ambient temperature in insulated container 176 during distance d₂ between location 230 and first geographic location 210. In some situations, it may be beneficial and/or more efficient for the user's goods to already have been picked up by the vehicle 170 or the vehicle 170 prepared to provide the requested service prior to the user meeting vehicle at first geographic location 210.

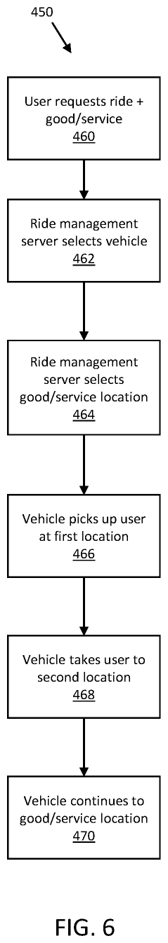

Referring next to FIG. 6 in combination with FIGS. 1 and 2, an illustrative method 450 for providing a good or service is provided. In some exemplary embodiments, method 450 follows the dash-dash lines in FIG. 2 from initial location 240 of vehicle 170 to the location 230 associated with the good/service.

In block 460, a user associated with personal electronic device 110 in geographic area 200 requests transportation from a first geographic location 210 to a second geographic location 220, as well as a good or service associated with a geographic location 230.

In block 462, the ride service management server 140 selects a vehicle 170 to provide transportation to the user. Ride management server 140 may identify one or more vehicles 170 in geographic area 200, such as vehicles at locations 240, 242, and 244. In some embodiments, ride management server 140 is in communication with computing device 172 in one or more vehicles 170 to determine a location 240 and/or status of vehicle 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, a rating of a driver associated with vehicle 170, acceptance of the driver associated with vehicle 170 to accept the requested user, the distance d₄ between the current geographic location 240 of the vehicle 170 and first geographic location 210 of the user associated personal electronic device 110, the distance d₁ between the first geographic location 210 of the user and the second geographic location 220, the distance d₃ between the second geographic location 220 and the location 230 associated with the good/service 230, and/or the total distance d₄+d₁+d₃.

In block 464, the ride service management server 140 selects a location 230 associated with the requested good/service. Ride management server 140 may identify one or more locations associated with the requested good/service in geographic area 200, such as locations 230, 232, and 234. In some embodiments, ride management server 140 is in communication with good/service management server 150 to identify and select among locations 230, 232, and 234 for providing the good/service. Location 230 is selected over other locations, such as locations 232 and 234 based on one or more criteria. Exemplary criteria include, but are not limited to, availability or inventory of the requested good/service at the location, estimated time to complete the requested transportation and good/service delivery, a preference or selection of the user associated with personal electronic device 110 among locations 230, 232, and 234, a preference or selection of the driver associated with vehicle 170 among locations 230, 232, and 234, rating of the locations 230, 232, and 234 associated with the requested good/service, the distance d₄ between the current geographic location 240 of the vehicle 170 and first geographic location 210 of the user associated personal electronic device 110, the distance d₁ between the first geographic location 210 of the user and the second geographic location 220, the distance d₃ between the second geographic location 220 and the location 230 associated with the good/service 230, and/or the total distance d₄+d₁+d₃.

In some embodiments, block 462 is performed prior to block 464. In some embodiments, block 462 is performed following block 464. In some embodiments, block 462 is performed simultaneously with block 464.

In block 466, the vehicle 170 moves from location 240 to the first geographic location 210 of the user associated with personal electronic device 110, covering distance d₄. In some embodiments, the route associated with distance d₄ is provided to the computing device 172 of vehicle 170 by the ride service management server 140.

In block 468, the vehicle 170 transports the user associated with personal electronic device 110 from the first geographic location 210 to the second geographic location 220, covering distance d₁. In some embodiments, the route associated with distance d₁ is provided to the computing device 172 of vehicle 170 by the ride service management server 140. In some embodiments, vehicle 170 (or a driver associated therewith) may receive a good from the user associated with personal electronic device 110 for delivery to the location 230.

In block 470, the vehicle 170 transports the received good from the user from the second geographic location 220 to the location 230 associated with the requested good/service, covering distance d₃. In some embodiments, the route associated with distance d₃ is provided to the computing device 172 of vehicle 170 by the ride service management server 140.

Without intending to be limiting in any way, in some exemplary embodiments, method 450 may be used by a user to have vehicle 170 drop off a good, such as a package or dry cleaning, after dropping off the user at the second geographic location 220. In some embodiments, the user associated with personal electronic device 110 may have a good or item in need of service when the vehicle 170 arrives at location 210, and the good or item in need of service continues in the vehicle 170 to location 230 associated with the requested good or service after the user exits the vehicle at location 220. Arrival or delivery of the good may be coordinated goods/service provider 160 through goods/service management server 150. If the delivered good involves something which must be picked up at another time, such as dry cleaning, the system may coordinate the pickup of the item with another trip using any of methods 300, 250, 400, 450, 500, or 550.

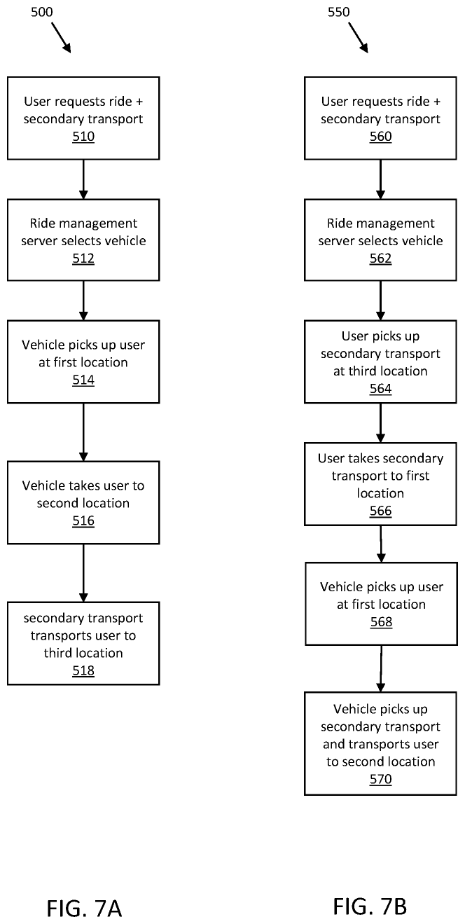

Referring next to FIG. 7A in combination with FIGS. 1 and 2, an illustrative method 500 for transporting a user associated with personal electronic device 110 is provided.

In block 510, a user associated with personal electronic device 110 in geographic area 200 requests transportation from a first geographic location 210 to a second geographic location 220, as well as a secondary transportation request within geographic area 200 to third geographic location 250. Exemplary secondary transportation requests include a connection to a second vehicle 170, a connection to a bus, a connection to a train, a connection to a taxi, a bicycle, an electric bicycle, a scooter, and an electric scooter to transport the user from the second geographic location 220 to the third geographic location 250.

In block 512, the ride service management server 140 selects a vehicle 170 to provide transportation to the user. Ride management server 140 may identify one or more vehicles 170 in geographic area 200, such as vehicles at locations 240, 242, and 244. In some embodiments, ride management server 140 is in communication with computing device 172 in one or more vehicles 170 to determine a location 240 and/or status of vehicle 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, a rating of a driver associated with vehicle 170, acceptance of the driver associated with vehicle 170 to accept the requested user, the distance d₄ between the current geographic location 240 of the vehicle 170 and the first geographic location 210, the distance d₁ between the first geographic location 210 and the second geographic location 220, and/or a distance between the second geographic location 220 and the third geographic location 250.

In block 514, the vehicle 170 moves from location 240 to the requested initial location 210 of the user associated with personal electronic device 110, covering distance d₄. In some embodiments, the route associated with distance d₄ is provided to the computing device 172 of vehicle 170 by the ride service management server 140. Once the user associated with personal electronic device 110 is picked up by vehicle 170, the requested good/service is provided to the user.

In block 516, the vehicle 170 transports the user associated with personal electronic device 110 from the requested initial location 210 to the second geographic location 220, covering distance d₁. In some embodiments, the route associated with distance d₁ is provided to the computing device 172 of vehicle 170 by the ride service management server 140.

In block 518, the secondary transportation is available for the user at the second geographic location 220. In some exemplary embodiments, the vehicle 170 may have the secondary transport, such as a scooter, electric scooter, bicycle, or electric bicycle, available to give the user at the second geographic location so that the user can continue their trip to the third geographic location 250. In some exemplary embodiments, the vehicle 170 may charge or re-charge the secondary transportation, such as an electric scooter or electric bicycle, to allow the user to continue traveling to the third geographic location 250. In some exemplary embodiments, the second geographic location 220 may be a bus stop, taxi stand, or train stations, and the ride management server 140 provides a ticket or other credential to the user, such as via personal electronic device 110, to board a bus, taxi, train, or other secondary transportation at the second geographic location 220 to continue travelling to the third geographic location 250.

Without intending to be limiting in any way, in some exemplary embodiments, method 500 may be used by a user to obtain transportation using two different modes, such as a ride in vehicle 170 from the first geographic location 210 to a second geographic location 220, such as a train station or bus stop, and then riding the train or bus from the second geographic location 220 to the third geographic location 250.

Referring next to FIG. 7B in combination with FIGS. 1 and 2, an illustrative method 500 for transporting a user associated with personal electronic device 110 is provided.

In block 560, a user associated with personal electronic device 110 in geographic area 200 requests secondary transportation from a third geographic location 250 within geographic area 200 to a first geographic location 210, as well as a request for transportation from the first geographic location 210 to a second geographic location 220. Exemplary secondary transportation requests include a connection to a second vehicle 170, a connection to a bus, a connection to a train, a connection to a taxi, a bicycle, an electric bicycle, a scooter, and an electric scooter to transport the user from the third geographic location 250 to the first geographic location 210.

In block 562, the ride service management server 140 selects a vehicle 170 to provide transportation to the user. Ride management server 140 may identify one or more vehicles 170 in geographic area 200, such as vehicles at locations 240, 242, and 244. In some embodiments, ride management server 140 is in communication with computing device 172 in one or more vehicles 170 to determine a location 240 and/or status of vehicle 170. Vehicle 170 at location 240 is selected over other vehicles 170, such as vehicles 170 at locations 242 and 244 based on one or more criteria. Exemplary criteria include, but are not limited to, availability of the vehicle 170, ability of vehicle 170 to provide the requested good/service, estimated time to complete the requested transportation and good/service delivery, a rating of a driver associated with vehicle 170, acceptance of the driver associated with vehicle 170 to accept the requested user, the distance d₄ between the current geographic location 240 of the vehicle 170 and the first geographic location 210, the distance d₁ between the first geographic location 210 and the second geographic location 220, and/or a distance between the first geographic location 210 and the third geographic location 250.

In block 564, the secondary transportation is available for the user at the third geographic location 250. In some exemplary embodiments, the second geographic location 220 may be a bus stop, taxi stand, or train stations, and the ride management server 140 provides a ticket or other credential to the user, such as via personal electronic device 110, to board a bus, taxi, train, or other secondary transportation at the third geographic location 250 to travel to the first geographic location 210, as shown in block 568.

In block 568, the vehicle 170 moves from location 240 to the requested initial location 210 of the user associated with personal electronic device 110, covering distance d₄. In some embodiments, the route associated with distance d₄ is provided to the computing device 172 of vehicle 170 by the ride service management server 140. In some embodiments, the ride service management server 140 may adjust a start time and/or a route to cover distance d₄ such that the vehicle 170 arrives at the first geographic location 210 at a specified or expected time of arrival of the user associated with the personal electronic device 110 arriving via the secondary transportation. Such a specified or expected time may be determined by the ride service management server 140 based on one or more of distance, expected speed, a schedule associated with the secondary transportation, traffic, road construction, time of day, type of road, speed limits, past history, number of stops, progress along the route, and the like.

In some exemplary embodiments, the vehicle 170 may collect the secondary transport, such as a scooter, electric scooter, bicycle, or electric bicycle, available to give the user at the second geographic location so that the user can continue their trip to the third geographic location 250. In some exemplary embodiments, the vehicle 170 may charge or re-charge the secondary transportation, such as an electric scooter or electric bicycle, upon collection.

In block 570, the vehicle 170 transports the user associated with personal electronic device 110 from the requested initial location 210 to the second geographic location 220, covering distance d₁. In some embodiments, the route associated with distance d₁ is provided to the computing device 172 of vehicle 170 by the ride service management server 140.

Without intending to be limiting in any way, in some exemplary embodiments, method 550 may be used by a user to obtain transportation using two different modes, such as riding an electric scooter from the third geographic location 250 to the first geographic location 210, and then riding in vehicle 170 from the first geographic location 210 to a second geographic location 220.

While many of the examples herein are described with respect to delivery or receipt of goods, the methods, systems, features, functions, techniques, and improvements may also be applicable to the delivery or receipt of services.

Any of the techniques, improvements, features, functions, or processes described herein may be implemented in the form of a method. The method may be performed by one or more computer processors or systems along with one or more of the devices, components, elements, and/or modules described herein. The method(s) may be performed, at least in part, by executing non-transitory computer-executable software instructions that are stored in one or more non-transitory memory devices or systems.

Any of the techniques, improvements, features, functions, or processes described herein may be implemented in the form of a system. The system may include any combination of the devices, computers, components, elements, and/or modules. Any of the devices, components, elements, and/or modules may also utilize the software platforms, software applications, software, and/or software tools described herein.

The techniques, elements, components, methods, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure is presented for purposes of illustration and description. Other modifications and variations may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention except as limited by the prior art.

What is claimed is:

1. A method for providing transportation and a requested good or service, the method comprising:
receiving, at a first computer, a first electronic message sent from a second computer over a network, wherein the first electronic message includes a first request for transportation from a first geographic location to a second geographic location;
receiving, at the first computer, a second electronic message from the second computer over the network, wherein the second electronic message includes a second request for a good or service;
determining a physical location where the good or service is available and linking the physical location with the second request;
selecting a vehicle from a pool of available vehicles, wherein the selection is based at least in part on initial geographic locations of each of the available vehicles, respectively, relative to the first geographic location;
calculating a first route from the initial geographic location of the selected vehicle to the first geographic location;
calculating a second route from the first geographic location to the physical location where the good or service is available;
calculating a third route from the physical location where the good or service is available to the second geographic location; and
transmitting the first, second, and third routes to a third computer in the selected vehicle and dispatching the selected vehicle to the initial geographic location.

2. The method of claim 1 further comprising:
moving the selected vehicle from the initial geographic location of the selected vehicle to the first geographic location along the first route;
permitting a user to enter the vehicle at the first geographic location;
moving the selected vehicle from the first geographic location to the location associated with the requested good or service along the second route; and
moving the selected vehicle from the location associated with the requested good or service to the second geographic location along the third route.

3. The method of claim 2 further comprising waiting for a signal that the requested good or service is received before beginning the moving of the selected vehicle from the location associated with the requested good or service along the third route.

4. The method of claim 1 wherein the selected vehicle is an autonomous vehicle and the third computer is configured to control the autonomous vehicle to follow the transmitted first, second, and third routes.

5. The method of claim 1 wherein the good or service is a good and the good is provided to the user while the user is in the selected vehicle.

6. The method of claim 1 wherein the good or service is a service and the service is provided to the user while the user is in the selected vehicle.

7. The method of claim 1 wherein one or more of calculating the first route, the second route, and the third route includes calculating transit times for each of a plurality of potential routes and selecting the potential route with shortest transit time from among the plurality of potential routes.

8. The method of claim 7 wherein calculating the transit times for each of the plurality of routes is based on at least a distance and a traffic status of each route.

9. The method of claim 1 further comprising transmitting an estimated arrival time for the physical location where the good or service is available to a computer associated with the provider of the good or service.

10. A system for providing transportation and providing a requested good or service, the system comprising:
a pool of available vehicles; and
a computer executing application software which directs the computer to:
receive a first request for transportation from a first geographic location to a second geographic location, the first request being sent from a second computer and received at the computer over a network;
receive a second request for a good or service and associate the second request for the good or service with a location, the second request being sent from the second computer and received over the network;
select a vehicle from the pool of available vehicles, wherein said selection is based at least in part on the selected vehicle having an ability to facilitate delivery of the requested good or service while the user is in the selected vehicle and further based on an initial geographic location of the selected vehicle relative to the first geographic location;
determine a first route from an initial geographic location of the selected vehicle to the first geographic location;
determine a second route from the first geographic location to the second geographic location; and
transmit the first and second routes to a third computer configured to provide driving directions to the selected vehicle.

11. The system of claim 10 wherein the good or service is a good and the good is to be provided to the user while the user is in the selected vehicle.

12. The system of claim 10 wherein the good or service is a service and the service is to be provided to the user while the user is in the selected vehicle.

13. The system of claim 10 wherein the vehicle is autonomous, the application software further directing the computer to:
navigate the selected vehicle along the first route from the initial geographic location of the vehicle to the first geographic location;
permit a user to enter the selected vehicle at the first geographic location; and
navigate the selected vehicle along the second route from the first geographic location to the location associated with the requested good or service.

14. The system of claim 13 wherein permitting a user to enter the selected vehicle includes electronically unlocking the door of the autonomous vehicle.

15. A method for providing transportation and a requested good, the method comprising:
receiving at a first computer a first electronic message sent from a second computer over a network, wherein the first electronic message includes a first request for transportation from a first geographic location to a second geographic location, and wherein the first electronic message further includes a second request for a good;
determining a physical location where the good is available;
selecting a vehicle from a list of available vehicles, wherein the selection is based at least in part on initial geographic locations of each of the available vehicles, respectively, relative to the physical location where the good is available;
calculating a first route from the initial geographic location of the selected vehicle to the physical location where the good is available;
calculating a second route from the physical location where the good is available to the first geographic location;
calculating a third route from the first geographic location to the second geographic location; and
transmitting the first, second, and third routes to a third computer associated with the selected vehicle; and
dispatching the selected vehicle along the first route to the physical location where the good is available.

16. The method of claim 15 further comprising identifying a secondary type of transportation available near the second geographic location for transport to a third geographic location.

17. The method of claim 15 wherein the selected vehicle is an autonomous vehicle and the third computer is configured to direct the autonomous vehicle to follow the transmitted first, second, and third routes.

18. The method of claim 15 further comprising receiving the good into the selected vehicle at the physical location where the good is available.

19. The method of claim 18 further comprising dispatching the selected vehicle along the second route to the first geographic location after the good is received in the vehicle.

20. The method of claim 19 further comprising dispatching the selected vehicle along the third route to the second geographic location after a passenger has entered the vehicle at the first geographic location.
